(19) United States
(12) Patent Application Publication
(10) Pub. No.: US 2015/0038125 A1
(43) Pub. Date: Feb. 5, 2015

(54) Dialer Detection and Conversational Traffic Differentiation for the Purpose of Optimal Call Termination

(71) Applicants: Gable Baldridge, Frisco, TX (US); Cheryl Fluhler, Elgin, IL (US)

(72) Inventors: Gable Baldridge, Frisco, TX (US); Cheryl Fluhler, Elgin, IL (US)

(21) Appl. No.: 14/447,041

(22) Filed: Jul. 30, 2014

Related U.S. Application Data
(60) Provisional application No. 61/861,168, filed on Aug. 1, 2013.

(51) Int. Cl. H04M 3/436; H04W 4/16

(52) U.S. Cl. CPC H04M 3/436; H04W 4/16
USPC 455/414.1

(57) ABSTRACT

The invention is an algorithm that allows a service provider to differentiate dialer traffic from conversational traffic and to divert the dialer traffic and/or to block or release it, enabling the routing of dialer calls only to those carriers that offer favorable rate conditions for dialer traffic and conversational calls to another larger superset of least cost routing carriers. Additionally, the invention allows the service provider to block the dialer type traffic, in which case the algorithm returns a “release-back” code.

### CROSS REFERENCE TO RELATED APPLICATIONS

This application claims priority to U.S. provisional patent application 61/861,168, filed on Aug. 1, 2013.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of Invention

The invention relates to the field of voice telephony communications, specifically the fields of retail and wholesale voice telecommunications. More particularly, the invention relates to the field of real-time call routing.

2. Background of the Invention

The current state of knowledge is as follows.

Today, many telecommunications termination providers are averse to having too much (if any at all) dialer traffic. Dialer traffic is usually generated by an auto dialer, which is an electronic device or software that is capable of automatically dialing large numbers of simultaneous phone calls. Once the call has been answered, the auto dialer either plays a recorded message or connects the call to a live person. When an auto dialer plays a pre-recorded message, it's often called “voice broadcasting”, or “robocalling”. Some voice broadcasting messages ask the person who answers to press a button on their phone keypad, such as in opinion polls in which recipients are asked to press one digit if they support one side of an issue, or another digit if they support the other side. This type of call is often called “outbound interactive voice response”. When an auto dialer connects an answered call to a live agent, it is often called a “predictive dialer” or “power dialer”. A predictive dialer uses real-time analysis to determine the optimal time to dial more numbers, whereas a power dialer simply dials a pre-set number of lines when an agent finishes the previous call.

Thus, the call characteristics of dialer traffic are highly peaked (hundreds or thousands of calls per second), short ALOC (average length of calls), and low completion rates. This negatively impacts the telecommunications infrastructure, as high call attempts congest both traditional and VoIP networks. Thus, the telecommunications network elements are saturated with low or no revenue calls, supplanting conversational calls which have higher revenue and higher call completion rate. Since each call does not have typical duration and are often unanswered, the termination provider does not generate acceptable revenue, as call setup time is non-billable, dead time. The negative cost impact increased in early 2009, when downstream tier one providers began charging additional surcharges and penalties if the ALOC was too short, and/or if a high percentage of calls do not complete.

Currently, most termination providers have no desire to accept dialer traffic. So when choosing a terminating provider, (“SPs”) are tasked with understanding the additional surcharge layer of dialer traffic as well as continuously monitoring their traffic in order to avoid these fees.

### BRIEF SUMMARY OF THE INVENTION

The invention allows a telecommunications service provider (“SP”) to segregate all of its traffic into a dialer traffic category and a conversational traffic category. The separation of the traffic allows the SP to perform two important functions:

Maximize the SP's profitability by terminating the dialer traffic to carriers which have favorable dialer rates and to avoid the carriers which levy fees associated with the same dialer traffic.

To disentangle the traffic from the SP's congested network elements.

### BRIEF DESCRIPTION OF THE DRAWINGS

FIG. 1 is a flow chart evidencing the steps of a computer algorithm for segregating telephone calls into a status of dialer or non-dialer.

FIG. 2 is a network diagram, showing how the (“DDS”) fits into a telecommunications network and general call flow.

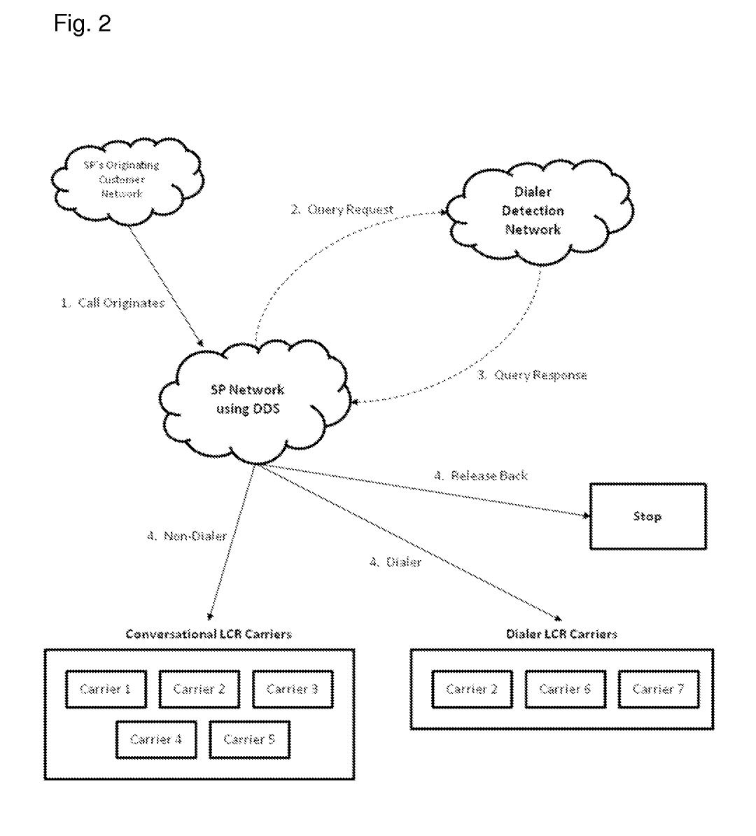

### DETAILED DESCRIPTION OF THE INVENTION

Acronyms:

ANI—Automatic Number Identification (which is the “calling” or “originating” telephone number)

CPS—Calls per Second

DDS—Dialer Detection System

LCR—Least Cost Routing

RG—Resource Group. Generic term which refers to a specific IP address, or group of IP addresses, a Trunk Group, or any other physical or logical entity which originates or terminates telephone calls.

SP—Service Provider

The invention allows a telecommunications SP, which uses DDS, to differentiate dialer traffic from conversational traffic and to divert the dialer traffic and/or to block or release it. This gives the SP the capability to route the dialer calls only to those carriers that offer favorable rate conditions for dialer traffic (some terminating carriers specialize in handling dialer traffic), and to route the conversational calls to a large superset of least cost routing carriers. Additionally, the invention allows the SP to block the dialer type traffic, in which case the algorithm returns a “release-back” code. The “release back” code is a special number contained within the query response which notifies the SP to release the call back to its customer. Different messaging protocols use different message codes to convey this.

In order to avoid the dialer fees charged by many terminating carriers, SPs often attempt to segregate the incoming dialer traffic by specifying different originating resource groups (RGs): One for dialer traffic and one for conversational traffic. This would be implemented for each originating carrier. However, this is usually not feasible, as both dialer and conversational traffic become mixed while routing through intermediate networks.

The algorithm that distinguishes between dialer and conversational traffic allows for a very high call per second throughput. Additionally, a “white list” mechanism is presented which allows particular calls to by-pass dialer detection. For the purposes of this application, a “white list” is defined as a list or database of valid senders from which a user is willing to accept calls or messages. For the purposes of this application, a “Dialer Condition” is defined as a call that that originates with the same ANI within the Dialer Interval. For the purposes of this application, a “Dialer Interval” is defined as a time interval (e.g. 500 ms).

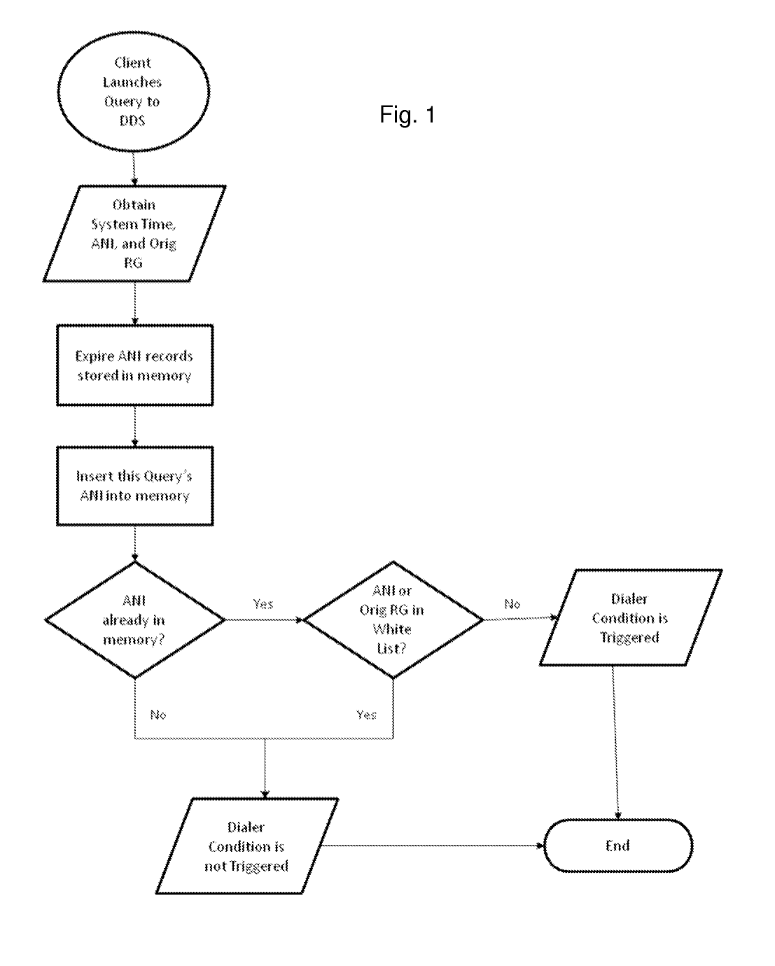

The DDS algorithm is shown in FIG. 1A and described below.

Step 1: SP launches query request to Dialer Detection System (“DDS”) platform.

Step 2: Obtain current system time.

Step 3: ANI is obtained from request for Dialer detection and for White List consideration

Step 4: Originating RG is obtained from request for White List consideration

Step 5: Records that are maintained in memory are expired (One record per ANI)
a. Traverse the table
b. If the time elapsed between the current system time and the time of the existing ANI record is greater than the Dialer Interval, then delete the record

Step 6: The ANI of this query is inserted into table in memory
a. Set Dialer Condition to false
b. Attempt to insert ANI into table
c. If ANI is already in table, a Dialer Condition could exist
   (i) If the Originating RG or the ANI is in the White List, a Dialer Condition is not triggered
   (ii) Otherwise, a Dialer Condition is triggered.

Step 7: If a Dialer Condition exists, the DDS responds with a message to either divert the call or stop the call.

The algorithm is applicable to any protocol that includes the ANI as part of the query request (e.g. SIP).

The DDS network diagram is shown in FIG. 1B and described below.

Step 1: Call originates from SP's customer

Step 2: SP launches a query to the DDS platform using any protocol (e.g. SIP, XML, etc.)

Step 3: SP receives back response indicating whether or not call is dialer

Step 4: SP then terminates in 3 possible manners:
a. To a set of LCR carriers that are optimal for conversational traffic;
b. To a set of LCR carriers that are optimal for dialer traffic; or
c. Releases call back to SP's originating customer or kill call.

We claim:

1. A telecommunications computer system comprised of one or more computers, each having a processor connected to memory and a graphical user interface, such system connected to one or more network lines or connections, which can be part of an Ethernet, wireless, cellular, direct cable, or similar link to other local computer systems, remote computer systems, or wide area communication networks such as the Internet, such computer system comprising software instructions encoded to perform the following steps: (a) identify incoming telephone calls as either dialer calls or conversational calls; and (b) segregate incoming dialer traffic from non-dialer traffic.

2. The telecommunications computer system of claim 1, further comprising step: (c) provide a response enabling the SP to route to preselected carriers.

3. The telecommunications computer system of claim 1, wherein step (a) is comprised of substeps: (i) receive a service provider query request to a DDS platform; (ii) obtain current system time; (iii) obtain an ANI from a request for Dialer detection and for White List consideration; (iv) obtain an origination RG from request for White List consideration; (v) execute the expiration of records that are maintained in memory (one record per ANI); and (vi) insert the ANI of the query into a table in the system's memory; and (vii) determine the presence or absence of a Dialer Condition.

4. The telecommunications computer system of claim 3, wherein step (a)(v) is comprised of substeps: (A) traverse a table; and (B) if the time elapsed between the current system time and the time of the existing ANI record is greater than a preset Dialer Interval, then delete the record.

5. The telecommunications computer system of claim 3, wherein step (a)(vi) is comprised of substeps: (A) set a Dialer Condition to false; (B) attempt to insert the ANI into the table; and (C) if the ANI is already in the table, a Dialer Condition could exist.

6. The telecommunications system of claim 5, further comprising wherein (1) if the originating RG or the ANI is in the White List, a Dialer Connection is not triggered and (2) otherwise, a Dialer Connection is triggered.

7. A telecommunications computer system comprised of one or more computers, each having a processor connected to memory and a graphical user interface, such system connected to one or more network lines or connections, which can be part of an Ethernet, wireless, cellular, direct cable, or similar link to other local computer systems, remote computer systems, or wide area communication networks such as the Internet, such computer system comprising software instructions encoded to perform the following steps: (a) a call originates from a service provider's customer; (b) the service provider launches a query to the DDS platform using a protocol from the group comprising SIP, XML or a similar protocol; (c) the service provider receives a response indicating whether or not call has dialer characteristics; (d) the service provider then: (i) terminates the call to a set of LCR carriers that are optimal for conversational traffic; (ii) terminates the call to a set of LCR carriers that are optimal for dialer traffic; or (iii) releases call back to SP's originating customer, thus ending the SP's interaction in the call flow.
